(19) United States
(12) Patent Application Publication
(10) Pub. No.: US 2016/0030925 A1
(43) Pub. Date: Feb. 4, 2016

(54) METHODS AND SYSTEMS FOR FORMING CATALYTIC ASSEMBLIES, AND RELATED CATALYTIC ASSEMBLIES

(71) Applicant: Seerstone LLC, Provo, UT (US)

(72) Inventor: Dallas B. Noyes, Provo, UT (US)

(73) Assignee: Seerstone LLC, Provo, UT (US)

(21) Appl. No.: 14/775,923

(22) PCT Filed: Mar. 14, 2014
(86) PCT No.: PCT/US14/27500

§ 371 Date: Sep. 14, 2015

Related U.S. Application Data
(60) Provisional application No. 61/791,808, filed on Mar. 15, 2013.

(51) Int. Cl. B01J 23/70; B01J 23/20; B01J 23/24; B01J 19/24; B01J 23/38; B01J 21/18; B01J 37/02; B01J 35/00; B01J 23/32

(52) U.S. Cl. CPC B01J 23/70; B01J 35/0006; B01J 35/0013; B01J 23/20; B01J 23/24; B01J 23/32; B01J 23/38; B01J 21/18; B01J 21/185; B01J 37/0221; B01J 19/2485; B01J 2219/24

(57) ABSTRACT

A method of forming a catalytic assembly comprises forming a support structure comprising at least one surface comprising at least one catalyst material. At least one mounted nanocatalyst is formed on the at least one support structure, the at least one mounted nanocatalyst comprising a nanoparticle of the at least one catalyst material bound to a nanostructure. A catalytic assembly and system for producing a catalytic assembly are also described.

### PRIORITY CLAIM

This application claims the benefit of the filing date of United States Provisional Patent Application Serial No. 61/791,808, filed Mar. 15, 2013, for “Methods and Systems for Forming Catalytic Assemblies, and Related Catalytic Assemblies,” the disclosure of which is hereby incorporated herein in its entirety by this reference.

### FIELD

Embodiments of the disclosure relate generally to methods and systems for forming catalytic assemblies, and to related catalytic assemblies. More specifically, embodiments of the disclosure relate to methods and systems for forming catalytic assemblies including catalyst nanoparticles bound to solid carbon structures on a support structure, and to related catalytic assemblies.

### BACKGROUND

This application builds upon the disclosure of co-pending U.S. patent application Ser. No. 13/263,311, filed on Oct. 6, 2011, which is a national phase entry of International Application Number PCT/US2010/029934 filed Apr. 5, 2010 and published in English as International Publication Number WO 2010/120581, which itself claims the benefit under 35 U.S.C. §119(e) to U.S. Ser. No. 61/170,199.

Catalytic reduction of gaseous materials typically involves the use of a catalytic assembly including porous honeycomb structures or pellets (e.g., beads) coated with a catalytic material. Generally, a gaseous stream including the gaseous materials is directed into the catalytic assembly, wherein the gaseous materials interact with the catalytic material coated on the honeycomb structures or the pellets under particular processing conditions (e.g., temperatures, pressures, etc.) to at least partially convert the gaseous materials into one or more other materials. Unfortunately, such catalytic assemblies can exhibit limited effectiveness due to limited catalytic surface area (i.e., which limits catalytic activity).

One approach toward increasing catalytic surface area in catalytic assemblies has been to incorporate catalyst nanoparticles (i.e., which can exhibit high specific surface areas) therein. However, catalyst nanoparticles may induce resistance to flow (e.g., pressure drops), compromising the rate at which a gaseous stream is processed. Namely, as particle size is reduced, the size of the spaces or openings between adjacent particles is correspondingly reduced, decreasing the flow rate of a gaseous stream through the particles. In addition, the use of catalyst nanoparticles in catalytic assemblies has been also hindered by problems associated with high manufacturing costs, agglomeration (e.g., clumping) of catalyst nanoparticles under typical processing conditions, and undesired removal of entrained catalyst nanoparticles from the catalytic assemblies.

Accordingly, there remains a need for catalytic assemblies, along with methods and systems for forming the catalytic assemblies, providing the benefits of catalytic reduction without one or more of the foregoing disadvantages of conventional catalytic assemblies.

### DISCLOSURE

In accordance with one embodiment of the disclosure, a method of forming a catalytic assembly comprises forming a support structure comprising at least one surface comprising at least one catalyst material. At least one mounted nanocatalyst is formed on the at least one support structure, the at least one mounted nanocatalyst comprising a nanoparticle of the at least one catalyst material bound to a nanostructure.

In additional embodiments, a catalytic assembly comprises a support structure comprising at least one surface comprising at least one catalyst material, and at least one mounted nanocatalyst comprising at least one nanoparticle of the at least one catalyst material bound to at least one nanostructure bound to the least one support structure.

In yet additional embodiments, a system for forming a catalytic assembly comprises a reactor configured to withstand temperatures up to about 1200° C. and pressures up to about 6.90×10⁹ pascal, and comprising a shell, a reaction gas inlet, and a reaction gas outlet. The shell at least partially defines a reaction chamber configured to receive at least one support structure, the shell configured for placing the at least one support structure within the reaction chamber and for removing the at least one support structure from the reaction chamber. The reaction gas inlet extends through an end cap of the shell and is configured to deliver a gaseous reaction stream into the reaction chamber. The reaction gas outlet extends through another end cap of the shell and is configured to remove a reaction product stream from the reaction chamber.

### BRIEF DESCRIPTION OF THE DRAWINGS

FIGS. 1A through 1C are simplified side-elevation and cross-sectional views illustrating different process stages and structures for a method of foil ling a catalytic assembly, in accordance with embodiments of the disclosure;

FIG. 2 is a cross-sectional view of a reactor for use in forming a catalytic assembly, in accordance with embodiments of the disclosure; and

FIG. 3 is a simplified side-elevation of a support structure for use in forming a catalytic assembly, in accordance with embodiments of the disclosure.

### MODE(S) FOR CARRYING OUT THE INVENTION

Methods and systems for forming catalytic assemblies are described, as are related catalytic assemblies. In some embodiments, a method of forming a catalytic assembly includes forming at least one support structure including at least one catalyst-containing surface. The support structure may include nested structures, each of the nested structures including at least one catalyst-containing surface. The at least one catalyst-containing surface includes at least one catalyst material suitable for catalyzing a target reaction and for catalyzing the formation of solid carbon structures (e.g., carbon nanotubes, carbon nanofibers, graphitic nanofibers, etc.). The support structure may be exposed to at least one carbon oxide and at least one gaseous reducing material to form a catalytic assembly including at least one carbon material on the at least one catalyst-containing surface of the support structure. The carbon material may be formed of and include catalyst-containing structures, each comprising a catalyst nanoparticle bound to a solid carbon structure. The catalytic assembly may exhibit properties desirable for use in a wide variety of applications. For example, the catalytic assembly may exhibit increased catalytic surface area, reduced pressure drop, reduced agglomeration of catalyst nanoparticles, and increased catalyst nanoparticle retention as compared to many conventional catalytic assemblies.

The following description provides specific details, such as catalyst types, stream compositions, and processing conditions (e.g., temperatures, pressures, etc.) in order to provide a thorough description of embodiments of the disclosure. However, a person of ordinary skill in the art will understand that the embodiments of the present disclosure may be practiced without employing these specific details. Indeed, the embodiments of the disclosure may be practiced in conjunction with conventional systems and methods employed in the industry. In addition, only those process components and acts necessary to understand the embodiments of the disclosure are described in detail below. A person of ordinary skill in the art will understand that some process components (e.g., pipelines, line filters, valves, temperature detectors, flow detectors, pressure detectors, and the like) are inherently disclosed herein as being in common practice in the chemical industry and that adding various conventional process components and acts would be in accord with the disclosure. The drawings accompanying the disclosure are for illustrative purposes only, and are not meant to be actual views of any particular material, reactor, or system. Additionally, elements common between figures may retain the same numerical designation.

As used herein, the “configured” refers to a shape, material composition, and arrangement of one or more of at least one structure and at least one apparatus facilitating operation of one or more of the structure and the apparatus in a pre-determined or intended way.

As used herein, the term “substantially” in reference to a given parameter, property, or condition means and includes to a degree that one of ordinary skill in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, relational terms, such as “first,” “second,” “top,” “bottom,” “upper,” “lower,” “over,” “under,” etc., are used for clarity and convenience in understanding the disclosure and accompanying drawings and do not connote or depend on any specific preference, orientation, or order, except where the context clearly indicates otherwise.

As used herein, the singular forms “a,” “an,” and “the” are intended to include the plural forms as well, unless the context clearly indicates otherwise.

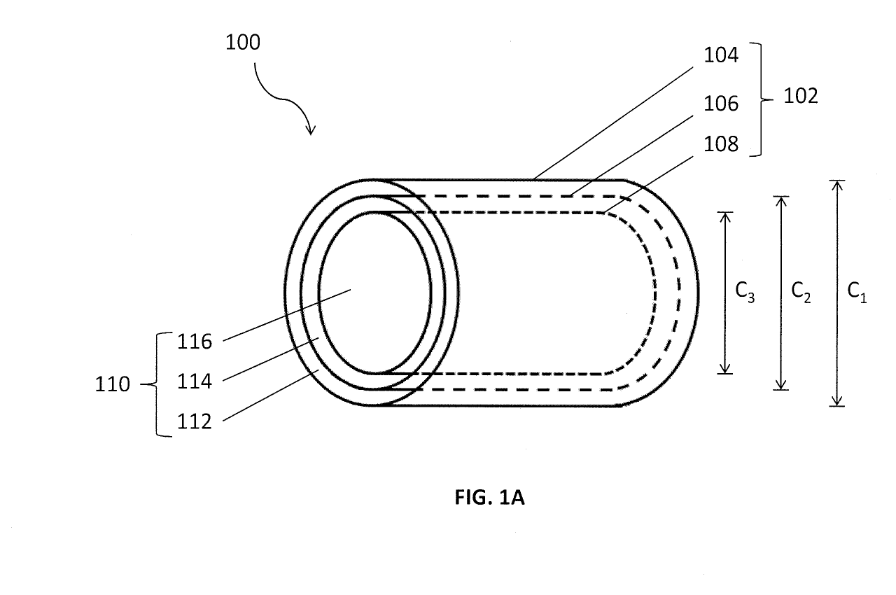

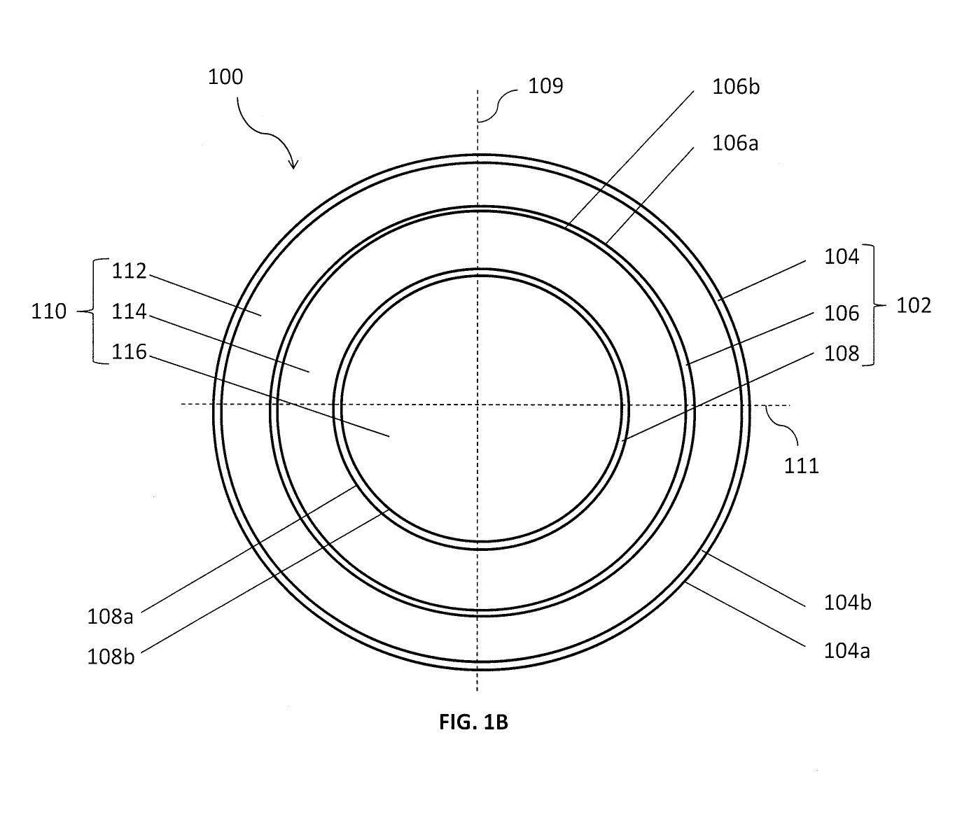

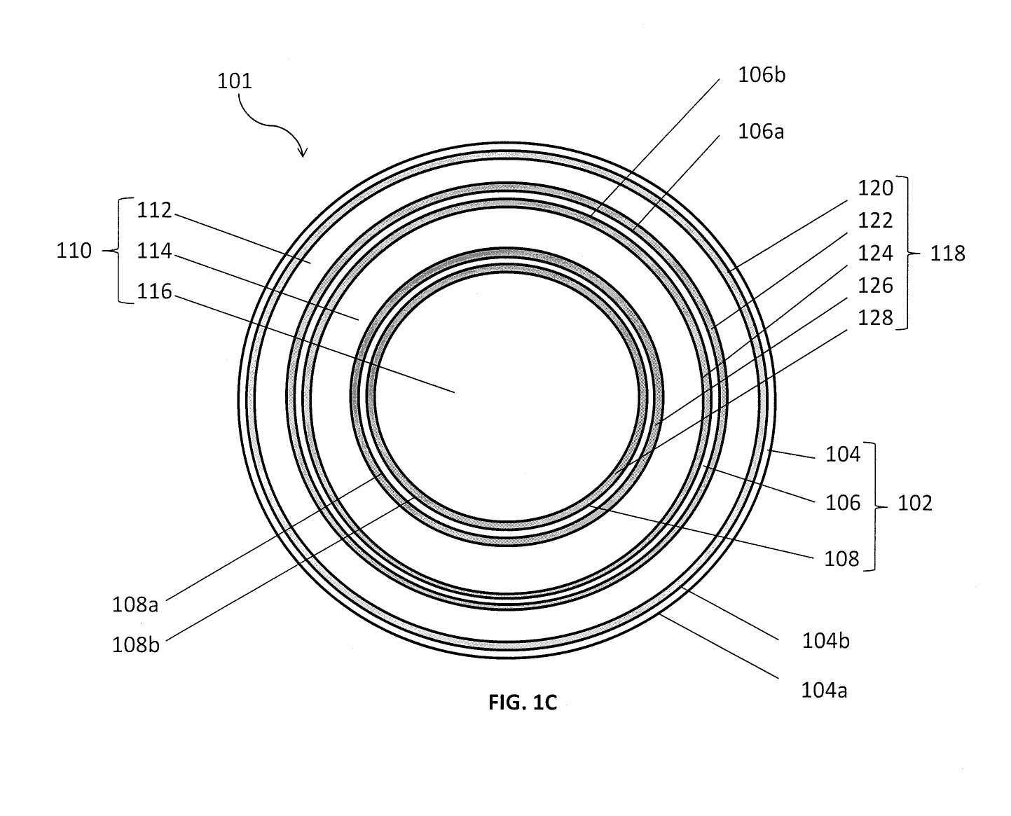

FIGS. 1A through 1C are simplified perspective (FIG. 1A) and cross-sectional views (FIGS. 1B and 1C) views illustrating embodiments of a method of forming a catalytic assembly including carbon material on a support substrate, the carbon material formed of and including catalyst-containing structures each comprising a catalyst nanoparticle bound to a solid carbon structure. With the description as provided below, it will be readily apparent to one of ordinary skill in the art that the methods described herein may be used in various applications. In other words, the methods of the disclosure may be used whenever it is desired to form catalyst-containing structures each comprising a catalyst nanoparticle bound to a solid carbon structure on at least a portion of a support structure.

Referring to FIGS. 1A and 1B, a method of the disclosure includes forming a support structure 100. As shown in FIGS. 1A and 1B, the support structure 100 may include nested structures 102. As used herein, the term “nested structures” means and includes an arrangement of structures wherein at least one of the structures is provided within a space at least partially surrounded by at least one other of the structures. The nested structures 102 may include any desired number of structures permitting the formation of a carbon material in spaces between adjacent nested structures, as described in further detail below. By way of non-limiting example, the nested structures 102 may include a first structure 104, a second structure 106 nested within (e.g., inside) the first structure 104, and a third structure 108 nested within the second structure 108.

While various embodiments herein describe or illustrate the nested structures 102 as including three structures (e.g., the first structure 104, the second structure 106, and the third structure 108), the nested structures 102 may, alternatively, include a different number of structures. For example, the nested structures 102 may include greater than or equal to two structures in a nested relationship, such as greater than or equal to three structures, greater than or equal to five structures, or greater than or equal to seven structures. While various embodiments herein describe or illustrate the support structure 100 as including the nested structures 102, the support structure 100 may, alternatively, be formed of include a single structure. For example, the support structure 100 may be formed of and include a single structure (e.g., the first structure 104) without at least one additional structure (e.g., the second structure 106, the third structure 108, etc.) nested within the single structure.

Each of the nested structures 102 may exhibit a different cross-sectional size (e.g., diameter, width) than each other of the nested structures 102. For example, as shown in FIG. 1A, the second structure 106 may exhibit a cross-sectional size C₂ larger than a cross-sectional size C₃ of the third structure 108, and the first structure 104 may exhibit a cross-sectional size C₁ larger than the cross-sectional size C₂ of the second structure 106. In addition, each of the nested structures 102 may exhibit a desired length. Each of nested structures 102 may exhibit substantially the same length, or at least one of the nested structures 102 may exhibit a length different than that of at least one other of the nested structures 102. In some embodiments, each of the nested structures 102 exhibits substantially the same length. The support structure 100 (e.g., comprising the nested structures 102, or a single structure) may have any desired overall size, such as an overall cross-sectional size (e.g., corresponding to the cross-sectional size C₁ of the first structure 104) greater than or equal to about 1×10⁻⁶ meter, such as greater than or equal to about 1×10⁻³ meter, greater than or equal to about 1×10⁻² meter, greater than or equal to about 1×10⁻¹ meter, greater than or equal to about one (1) meter, greater than or equal to about five (5) meters, or greater than or equal to about 10 meters.

Each of the nested structures 102 may independently exhibit a desired shape (i.e., geometric configuration), such as a substantially hollow and elongated shape. The nested structures 102 may each exhibit substantially the same shape, or at least one of the nested structures 102 may exhibit a shape different than at least one other of the nested structures 102. In some embodiments, each of the nested structures 102 exhibits substantially the same shape. For example, as shown in FIG. 1A, each of the nested structures 102 may exhibit substantially the same tubular shape. In additional embodiments, at least one of the nested structures 102 may exhibit a different shape, such as a hollow or substantially solid (e.g., substantially free of void spaces) form of a spherical, semi-spherical, cylindrical, semi-cylindrical, cubic, cuboidal, conical, triangular prismatic, or irregular shape. By way of non-limiting example, at least one of the nested structures 102 may exhibit a shape common in conventional fixed bed reactors, such as a conventional ring shape (e.g., Raschig ring shape, a Goodwin ring shape, a Lessing ring shape, a Prym Ring, etc.), a conventional saddle shape, or a snowflake shape. Each hollow and elongated shape (e.g., tubular shape) of the nested structures 102 may include substantially solid sidewalls, or at least one hollow and elongated shape of the nested structures 102 may include at least one sidewall including at least one perforation (e.g., hole, trench, etc.) extending at least partially therethrough.

Referring to FIG. 1B, a longitudinal axis of each of the nested structures 102 may be substantially aligned in a plane through a longitudinal axis 109 of the support structure 100. In addition, a lateral axis of each of the nested structures 102 may be substantially aligned in a plane through a lateral axis 111 of the support structure 100. Accordingly, each of the nested structures 102 may be substantially concentrically aligned relative to each other of the nested structures 102. Alternatively, at least one of the nested structures 102 may exhibit at least one of a longitudinal axis and a lateral axis offset from the longitudinal axis 109 and the lateral axis 111 of the support structure 100, respectively. In some embodiments, each of the nested structures 102 is eccentrically aligned relative to each other of the nested structures 102.

The nested structures 102 may be substantially isolated from one another, such that at least a majority of the nested structures 102 do not directly contact an adjacent structure of the nested structures 102. The support structure 100 may, for example, include one or more structures (e.g., mounts, spacers, etc.) configured and positioned to space adjacent structures of the nested structures 102 apart from one another. Adjacent structures of the nested structures 102 may, for example, be spaced apart from one another by a distance within a range of from about 0.1 millimeter (mm) to about 50 cm. Accordingly, adjacent structures of the nested structures 102 may at least partially define chambers 110 of the support structure 100. For example, as shown FIG. 1B, a first chamber 112 of the support structure 100 may be at least partially defined by an inner surface 104b of the first structure 104 and an outer surface 106a of the second structure 106 of the support structure 100, a second chamber 114 of the support structure 100 may be at least partially defined by an inner surface 106b of the second structure 106 and an outer surface 108a the third structure 108 of the support structure 100, and a third chamber 116 of the support structure 100 may be at least partially defined by an inner surface 108b of the third structure 108. Each of the chambers 110 may be substantially isolated from each other of the chambers 110, or at least one of the chambers 110 may be operatively connected to (i.e., integral with) at least one other of the chambers 110 (e.g., by way of at least one perforation extending completely though at least one of the nested structures 102). A size and a shape of each of the chambers 110 may at least partially depend on the size, shape, and alignment of the nested structures 102.

Each of the nested structures 102 may include at least one catalyst material. As used herein, the term “catalyst material” means and includes a material promoting the formation of a carbon material (e.g., carbon nanofibers, such as carbon nanotubes) through at least one reaction between a carbon oxide and a gaseous reducing material. The catalyst material may accelerate reaction rates, and may also enable the carbon material to be formed at relatively low temperatures. Faster reaction rates may enable the carbon material to have a smaller size (e.g., smaller diameter carbon nanotubes), while slower reaction rates may enable the carbon material to have larger size (e.g., larger diameter nanotubes). The catalyst material may be utilized with or without special preparation (e.g., acid washing).

As a non-limiting example, the catalyst material may comprise an element of Group 2 (e.g., beryllium, magnesium, calcium, strontium, barium), Group 3 (e.g., scandium, yttrium, lanthanide, actinide), Group 4 (e.g., titanium, zirconium, hafnium), Group 5 (e.g., vanadium, niobium, tantalum), Group 6 (e.g., chromium, molybdenum, tungsten), Group 7 (e.g., manganese, rhenium), Group 8 (e.g., iron, ruthenium, osmium), Group 9 (e.g., cobalt, rhodium, iridium), Group 10 (e.g., nickel, palladium, platinum), Group 11 (e.g., copper, silver, gold), Group 12 (e.g., zinc, cadmium), Group 13 (e.g., boron, aluminum, gallium, indium, thallium), Group 14 (e.g., silicon, germanium, tin, lead), or Group 15 (e.g., arsenic, antimony, bismuth) of the Periodic Table of Elements, oxides thereof, carbides thereof, alloys thereof, or combinations thereof. The catalyst material may, for example, comprise a metal known to be subject to metal dusting. As used herein, the term “metal dusting” refers to a corrosion phenomenon wherein structures formed of and including pure metals and metal alloys degrade (e.g., breakup) into powder or “dust” at temperatures within a range of from about 450° C. to about 850° C. in gaseous environments including carbon. In some embodiments, the catalyst material comprises at least one element selected from Groups 5 through 10 of the Periodic Table of Elements.

Various grades of the catalyst material may be used. For example, the catalyst material may be a grade of an iron-, chromium-, molybdenum-, cobalt-, tungsten-, or nickel-containing alloy or superalloy. Such materials commercially available from numerous sources, such as from Special Metals Corp., of New Hartford, New York, under the trade name INCONEL®, or from Haynes, Intl, Inc., of Kokomo, Indiana, under the trade name HASTELLOY® (e.g., HASTELLOY® B-2, HASTELLOY® B-3, HASTELLOY® C-4, HASTELLOY® C-2000, HASTELLOY® C-22, HASTELLOY® C-276, HASTELLOY® G-30, HASTELLOY® N, or HASTELLOY® W). Iron alloys, including steel, may contain various allotropes of iron, including alpha-iron (austenite), gamma iron, and delta-iron. In some embodiments, the catalyst material comprises an iron-containing alloy, wherein the iron is not in an alpha phase. As a non-limiting example, the catalyst material may comprise at least one of a low chromium stainless steel, steel, and cast iron (e.g., white cast iron). The catalyst material may comprise less than or equal to about 22 percent by weight (wt %) chromium, and less than or equal to about 14 wt % nickel (e.g., such as less than or equal to about 8 wt % nickel). In some embodiments, the catalyst material comprises 316L stainless steel. 316L stainless steel comprises from about 16 wt % chromium to about 18.5 wt % chromium, and from about 10 wt % nickel to about 14 wt % nickel.

At least a portion of the catalyst material may be included in each of the nested structures 102 as catalyst nanoparticles. As used herein, the term “nanoparticle” means and includes a particle (e.g., grain) of material having an average particle diameter of less than about one micron, such as least than or equal to about 500 nanometers (nm), less than or equal to about 50 nm, or less than or equal to about 5 nm. Each of the catalyst nanoparticles may be of a desired shape, such as at least one of a spherical shape, a hexahedral shape, an ellipsoidal shape, a cylindrical shape, a conical shape, or an irregular shape. In some embodiments, each of the catalyst nanoparticles has a substantially spherical shape. The size and shape of each of the catalyst nanoparticles may be selected based on a desired morphology of a carbon material to be formed on the support structure 100. For example, at least some of the catalyst nanoparticles may be configured (e.g., sized and shaped) to form carbon nanostructures (e.g., carbon nanotubes, carbon nanofibers) of a desired size and shape. A ratio between a size (e.g., diameter) of a catalyst nanoparticle and a diameter of a carbon nanostructure to be formed may, for example, be within a range of from about 1.2 to about 1.6. The catalyst nanoparticles may be monodisperse, wherein all of the catalyst nanoparticles are of substantially the same particle size and particle shape, or may be polydisperse, wherein the catalyst nanoparticles have a range of particle sizes and/or particle shapes.

Each of the nested structures 102 may independently include a substantially homogeneous distribution or a substantially heterogeneous distribution of the catalyst material. As used herein, the term “homogeneous distribution” means that amounts of a material (e.g., a catalyst material) do not vary throughout different portions (e.g., different lateral and longitudinal portions) of a structure. For example, if at least one of the nested structures 102 includes a substantially homogeneous distribution of the catalyst material, amounts of the catalyst material may not vary throughout different portions of the at least one of the nested structures 102. The at least one of the nested structures 102 may, for example, comprise a bulk structure of the catalyst material. In contrast, as used herein, the term “heterogeneous distribution” means amounts of a material (e.g., a catalyst material) vary throughout different portions of a structure. Amounts of the material may vary stepwise (e.g., change abruptly), or may vary continuously (e.g., change progressively, such as linearly, parabolically, etc.) throughout different portions of the structure. For example, if at least one of the nested structures 102 includes a substantially heterogeneous distribution of the catalyst material, amounts of the catalyst material may vary throughout at least one of different lateral portions and different longitudinal portions of the at least one of the nested structures 102. The at least one of the nested structures 102 may, for example, be formed of and include an at least partial coating of the catalyst material on another material (e.g., a non-catalyst material, another catalyst material, or a combination thereof).

Regardless of whether the catalyst material is homogeneously distributed or heterogeneously distributed, each of the nested structures 102 of the support structure 100 may include at least one catalyst-containing surface. As used herein, the term “catalyst-containing surface” means and includes a surface including catalyst material. As a non-limiting example, referring to FIG. 1B, at least one of the inner surface 104b and an outer surface 104a of the first structure 104 may include catalyst material, at least one of the inner surface 106b and the outer surface 106a of the second structure 106 may include catalyst material, and at least one of the inner surface 108b and the outer surface 108a of the third structure 108 may include catalyst material. In some embodiments, each surface of the nested structures 102 (e.g., each surface of the first structure 104, the second structure 106, and the third structure 108) of the support structure 100 comprises a catalyst-containing surface. In additional embodiments, at least one surface of the nested structures 102 comprises a catalyst-containing surface, and at least one other surface of the nested structures 102 comprises a non-catalyst-containing surface. By way of non-limiting example, referring to FIG. 1B, the inner surface 104b of the first structure 104 may comprise a catalyst-containing surface, and the outer surface 104a of the first structure 104 may comprise a non-catalyst-containing surface.

Each catalyst-containing surface of the nested structures 102 may be fainted of and include the same catalyst material, or at least one catalyst-containing surface of the nested structures 102 may be formed of and include a different catalyst material than at least one other catalyst-containing surface of the nested structures 102. Nested structures 102 including at least one catalyst-containing surface formed of and including a different catalyst material than at least one other catalyst-containing surface may facilitate the formation of different carbon morphologies, as described in further detail below. In some embodiments, each catalyst-containing surface of the nested structures 102 is fainted of and includes substantially the same catalyst material.

The support structure 100 including the nested structures 102 (or, alternatively, a single structure) may be formed using conventional processes (e.g., welding processes, material deposition processes, etc.) and conventional processing equipment (not shown), which are not described in detail herein. By way of non-limiting example, precursor structures to the nested structures 102 may independently be at least partially coated with a desired catalyst material (e.g., using at least one of electroless deposition, electrochemical deposition, calcination, and mechanical incorporation), and may be arranged and indirectly connected (e.g., through connection to at least one other structure) to form the support structure 100. As another non-limiting example, a preformed structure (e.g., a structure conventionally used as packing in distillation columns, such as a conventional ring or saddle) formed of and including a suitable catalyst material may be utilized as at least one component of the support structure 100.

Referring to FIG. 1C, a carbon material 118 may be formed on the nested structures 102 of the support structure 100 (FIGS. 1A and 1B) to form a catalytic assembly 101. The carbon material 118 may be foamed on at least the catalyst-containing surfaces of the nested structures 102. As a non-limiting example, as shown in FIG. 1C, if the inner surface 104b of the first structure 104, the outer surface 106a and the inner surface 106b of the second structure 106, and the outer surface 108a and the inner surface 108b of the third structure 108 each comprise catalyst-containing surfaces, a first carbon material 120 may be formed on the inner surface 104b of the first structure 104, a second carbon material 122 may be formed on the outer surface 106a of the second structure 106, a third carbon material 124 may be formed on the inner surface 106b of the second structure 106, a fourth carbon material 126 may be formed on the outer surface 108b of the third structure 108, and a fifth carbon material 128 may be formed on the inner surface 108a of the third structure 108.

Substantially the same carbon material 118 may be formed on each of the catalyst-containing surfaces of the nested structures 102, or the carbon material 118 fainted on at least one of the catalyst-containing surfaces of the nested structures 102 may be different than that formed on at least one other of the catalyst-containing surfaces of the nested structures 102. By way of non-limiting example, with continued reference to FIG. 1C, each of the first carbon material 120, the second carbon material 122, the third carbon material 124, the fourth carbon material 126, and the fifth carbon material 128 may be substantially the same, or at least one of the first carbon material 120, the second carbon material 122, the third carbon material 124, the fourth carbon material 126, and the fifth carbon material 128 may be different than at least one other of the first carbon material 120, the second carbon material 122, the third carbon material 124, the fourth carbon material 126, and the fifth carbon material 128. In some embodiments, substantially the same carbon material 118 is formed on each of the catalyst-containing surfaces of the nested structures 102.

The carbon material 118 may extend substantially continuously or substantially discontinuously across the catalyst-containing surfaces of the nested structures 102. For example, if a catalyst material extends substantially continuously across a catalyst-containing surface of the nested structures 102 (e.g., such as where the catalyst-containing surface comprises a surface of a bulk structure of the catalyst material, or comprises a surface of a substantially complete coating of the catalyst material on another material), the carbon material 118 on the catalyst-containing surface may extend substantially continuous across the catalyst-containing surface. Alternatively, if a catalyst material extends substantially discontinuously across a catalyst-containing surface of the nested structures 102 (e.g., such as where the catalyst-containing surface comprises a surface including a partial coating of catalyst material on another material), the carbon material 118 thereon may extend substantially discontinuously across the catalyst-containing surface. For example, the carbon material 118 may be located on portions of the catalyst-containing surface including the catalyst material, but may be absent from other portions of the catalyst-containing surface not including the catalyst material. In some embodiments, the carbon material 118 extends substantially continuously across each catalyst-containing surface of the nested structures 102.

The carbon material 118 may be foimed of and include catalyst-containing structures. Each of the catalyst-containing structures may include a catalyst nanoparticle bound to a solid carbon structure, such as a carbon nanostructure. As used herein, the term “nanostructure” means and includes an elongated structure having a cross-section or diameter of less than one micron, such less than or equal to about 500 nm, less than or equal to about 250 nm, or less than or equal to about 100 nm Carbon nanostructures include structures that are hollow (e.g., carbon nanotubes), and structures that are substantially free of void spaces (e.g., carbon nanofibers). In some embodiments, the carbon material 118 includes carbon nanotubes each including at least one catalyst nanoparticle bound thereto. The bound catalyst nanoparticle may be considered a mounted nanocatalyst. The catalyst nanoparticles may, for example, be bound to or embedded within tips (e.g., growth tips) of the carbon nanotubes. The catalyst nanoparticles may be substantially limited to the tips of the carbon nanotubes, or some of the catalyst nanoparticles may be bound to the carbon nanotubes at other locations, such as on sidewalls of the carbon nanotubes. The solid carbon structures may each be of the same structural type (e.g., carbon nanotubes, carbon nanofibers, etc.), or at least one of the solid carbon structures may be of a different structural type than at least one other of the solid carbon structures.

The solid carbon structures bound to the catalyst nanoparticles may be of any suitable size and shape. For example, if the solid carbon structures include carbon nanostructures (e.g., carbon nanotubes), a length to diameter ratio of each of the carbon nanostructures may be within a range of from about 10,000:1 to about 10:1, such as from about 1000:1 to about 100:1. Each of the solid carbon structures may be of substantially the same size, or at least one the solid carbon structures may be of a different size than at least one other of the solid carbon structures. Accordingly, a thickness of the carbon material 118 on each of the nested structures 102 may be substantially uniform, or may be substantially non-uniform. The carbon material 118 may at least partially fill at least one chamber (e.g., at least one of the first chamber 112, the second chamber 114, and the third chamber 112) of the support structure 100. In some embodiments, at least one chamber (e.g., at least one of the first chamber 112, the second chamber 114, and the third chamber 112) of the support structure 100 may be substantially filled with the carbon material 118. In such embodiments, the carbon material 118 may, for example, be substantially compacted within the support structure 100 so as to foim a mechanically stable, highly porous solid exhibiting a large surface area and a large number of nanocatalyst particles.

Each of the solid carbon structures may be larger than the catalyst nanoparticle bound thereto. The catalyst nanoparticle bound to each solid carbon structure may constitute greater than or equal to about one (1) percent by weight of the catalyst-containing structure (i.e., the combined weight of the solid carbon structure and the catalyst nanoparticle), such as greater than or equal to about five (5) percent by weight, greater than or equal to about ten (10) percent by weight, greater than or equal to about twenty (20) percent by weight, or greater than or equal to about thirty (30) percent by weight. By way of non-limiting example, if the solid carbon structure is a carbon nanotube and the catalyst nanoparticle is platinum, palladium, nickel, or iron, the catalyst nanoparticle may constitute greater than or equal to about ten (10) percent by weight of the catalyst-containing structure.

The catalyst nanoparticles may become bound to the solid carbon structures during the formation of the solid carbon structures. For example, during the formation of carbon nanostructures (e.g., carbon nanotubes, carbon nanofibers), catalyst nanoparticles may be separated from catalyst-containing surfaces of the nested structures 102 and may become bound to or embedded in the carbon nanostructures which grow therefrom (e.g., the catalyst nanoparticles may be embedded in growth tips of the carbon nanostructures). Suitable methods for forming the solid carbon structures, and hence the catalyst-containing structures and the carbon material 118, are described in U.S. patent application Ser. No. 13/263,311. The nested structures 102 may, for example, be exposed to at least one carbon oxide (e.g., carbon dioxide, carbon monoxide, or a combination thereof) and at least one gaseous reducing material (e.g., hydrogen gas; a hydrocarbon gas, such as methane, ethane, propane, butane, pentane, hexane; or a combination thereof) under suitable processing conditions (e.g., temperatures, pressures, etc.) to foam the solid carbon structures using at least one of a Bosch reaction, a Boudouard reaction (i.e., a reduction-oxidation reaction), and a CH₄ reduction reaction.

By way of non-limiting example, the solid carbon structures may be foil led on the catalyst-containing surfaces of the nested structures 102 by converting carbon dioxide (CO₂) and hydrogen gas (H₂) into solid carbon and water (H₂O) in the presence of the catalyst material, according to the following Bosch reaction:

CO_{2(g)}+2H_{2(g)} [symbol] C₍ₛ₎+H₂O_{(g)} (1).

The Bosch reaction represented by Equation 1 may be exothermic, and may be broken up into two steps, according to the equations:

CO_{2(g)}+H_{2(g)} [symbol] CO_{(g)}+H₂O_{(g)} (2), and

CO_{(g)}+H_{2(g)} [symbol] C₍ₛ₎+H₂O_{(g)} (3).

In the first step of the Bosch reaction, shown in Equation 2, CO₂ reacts with H₂ to create carbon monoxide (CO) and H₂O in an endothermic reaction. The endothermic reaction may utilize a theinial energy input of about 8.47 kcal/mol at 650° C. In the second step of the Bosch reaction, shown in Equation 3, CO reacts with H₂ to form solid carbon and H₂O in an xothermic reaction. If used to form carbon nanotubes, the exothermic reaction may, for example, facilitate a thermal energy output of about 33.4 kcal/mol (1.16×10⁴ joules/gram of C₍ₛ₎₎ at 650° C. The exothermic reaction may occur with stoichiometric amounts of reactants, or may occur with an excess amount of one of CO₂ and H₂.

In addition, the formation of the solid carbon structures through the Bosch reaction may be augmented using disproportionation of CO into solid carbon and CO₂, according to the following Boudouard reaction:

2CO_{(g)} [symbol] C₍ₛ₎+CO_{2(g)} (4).

The Boudouard reaction of Equation 4 may be exothermic at temperatures less than or equal to about 700° C. For example, if used to form CNTs, the Boudouard reaction may facilitate a thermal energy output of about 41.9 kcal/mol at 650° C. (i.e., a heat of formation (ΔH) of about −41.9 kcal/mol). At low temperatures, the Boudouard reaction may have a negative Gibbs free energy (AG), and the production of solid carbon and CO₂ may be spontaneous. At higher temperatures, AG for the Boudouard Reaction may be positive, such that the reverse reaction is spontaneous. The temperature at which AG is zero (i.e., the temperature above which the reverse Boudouard reaction is spontaneous, and below which the forward Boudouard reaction is spontaneous) may depend on the form of carbon produced.

As another non-limiting example, the solid carbon structures may be formed by converting CO₂ and methane (CH₄) into solid carbon and H₂O in the presence of the catalyst material, according to the following CH₄ reduction reaction:

CO_{2(g)}+CH_{4(g)} [symbol] 2C₍ₛ₎+2H₂O_{(g)} (5).

The CH₄ reduction reaction of Equation 5 may be exothermic, and may facilitate a thermal energy output of about 3.65 kcal/mol at standard conditions (25° C.). The CH₄ reduction reaction of Equation 5 may be broken up into two steps, according to the following reactions:

CH_{4(g)}+CO_{2(g)} [symbol] 2CO_{(g)}+2H_{2(g)} (6), and

CO_{(g)}+H_{2(g)} [symbol] C₍ₛ₎+H₂O_{(g)} 97).

If more than one of the reactions of Equations 1, 4, and 5 are used to form the solid carbon structures, the reactions may occur substantially simultaneously (e.g., a single-step reaction process), or may occur substantially consecutively (e.g., a multi-step reaction process, such as a process wherein different reactions are performed at different times by modifying at least one of the reactants and the processing conditions). In some embodiments, the reactions of Equations 1, 4, and 5 occur substantially simultaneously to form the solid carbon structures on the catalyst-containing surfaces of the nested structures 102.

The processing conditions used to form the solid carbon structures through one or more of Equations 1, 4, and 5 above may at least partially depend on the composition and particle size of the catalyst material at the catalyst-containing surfaces of the nested structures 102. For example, catalyst materials exhibiting small particle sizes generally exhibit optimum reaction temperatures at lower temperatures than the same catalyst materials exhibiting larger particle sizes. As a non-limiting example, the solid carbon structures (and, hence, the catalyst-containing structures and the carbon material 118) may be formed on the catalyst-containing surfaces of the nested structures 102 at a temperature within a range of from about 400° C. to about 1200° C. (e.g., from about 550° C. to about 1200° C., or from about 650° C. to about 750° C.), and a pressure within a range of from about 9.65×10⁵ pascal (i.e., about 14 pounds per square inch (psi)) to about 6.90×10⁹ pascal (i.e., about 1000000 psi), such as from about 9.65×10⁵ pascal to about 6.90×10⁶ pascal (i.e., about 1000 psi), or from about 1.38×10⁶ pascal (i.e., about 200 psi) to about 4.14×10⁶pascal (i.e., about 600 psi).

The partial pressure of water may be utilized to control the formation of the solid carbon structures. For example, the partial pressure of water within the support structure 100 (and/or a reactor surrounding the support structure 100) may be controlled to form solid carbon structures of a desired morphology (e.g., carbon nanofibers, such as carbon nanotubes), and to control the kinetics of solid carbon structure formation. Changing the partial pressure of water within the support structure 100 (and/or a reactor surrounding the support structure 100) may change carbon activity (A_{c}) within the support structure 100 (and/or a reactor surrounding the support structure 100). Without being bound to any particular theory, carbon activity (A_{c}) is believed to be a metric for determining which allotrope of solid carbon will be formed under particular reaction conditions (e.g., temperature, pressure, reactants, concentrations). For example, higher carbon activity may result in the formation of carbon nanotubes, and lower carbon activity may result in the formation of graphitic forms of solid carbon. Carbon activity for a reaction forming solid carbon from gaseous reactants can be defined as the reaction equilibrium constant times the partial pressure of gaseous products, divided by the partial pressure of reactants. For example, in the reaction, CO_{(g)}+H_{2(g)} [symbol] C₍ₛ₎+H₂O_{(g)}, with a reaction equilibrium constant of K, the carbon activity A_{c} is defined as K·(P_{CO}·P_{H2}/P_{H2O}). Thus, A_{c} is directly proportional to the partial pressures of CO and H₂, and inversely proportional to the partial pressure of H₂O. Higher P_{H2O} may inhibit CNT formation. The carbon activity of this reaction may also be expressed in terms of mole fractions and total pressure: A_{cc}=K·P_{T}(Y_{CO}·Y_{H2}/Y_{H2O}), where P_{T} is the total pressure and Y is the mole fraction of a species. Carbon activity may vary with temperature because reaction equilibrium constants vary generally with temperature. Carbon activity also varies with total pressure for reactions in which a different number of moles of gas are produced than are consumed. Mixtures of solid carbon allotropes and morphologies thereof can be achieved by varying the catalyst material and the carbon activity of reaction gases within the support structure 100 (and/or a reactor surrounding the support structure 100).

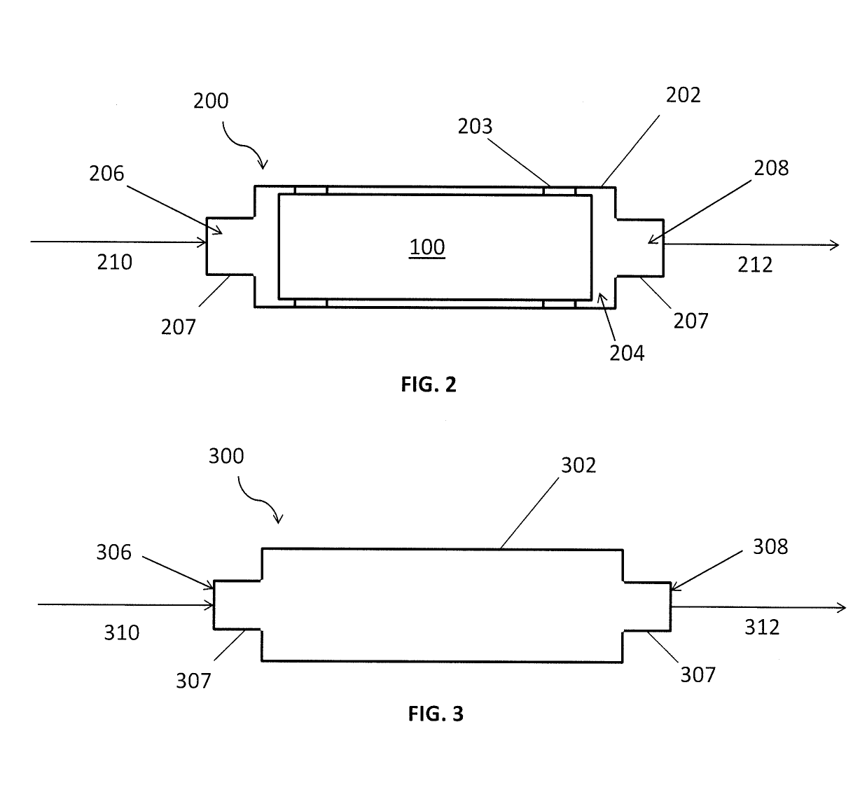

The nested structures 102 may be exposed to the carbon oxide and the gaseous reducing material through a variety of systems and methods. For example, referring to FIG. 2, a reactor 200 may be used to expose the support structure 100, including the nested structures 102 (FIGS. 1A and 1B), to the carbon oxide and the gaseous reducing material. The reactor 200 may be separate from the support structure 100, and may include a shell 202 at least partially defining a reaction chamber 204 configured to receive the support structure 100. The reaction chamber 204 may, for example, include one or more structures 203 for mounting the support structure 100 therein. The shell 202 may be configured to place the support structure 100 in the reaction chamber 204, and to remove the support structure 100 from the reaction chamber 204. The shell 202 may also define at least two end caps 207, such as at least two hemispherical end caps. A reaction gas inlet 206 may extend through at least one of the end caps 207, and may be configured to deliver a gaseous reaction stream 210 including the carbon oxide and the gaseous reducing material into the reaction chamber 204. A reaction product outlet 208 may extend through at least one other of the end caps 207, and may be configured to remove unreacted reaction gases (if any) and reaction products (e.g., mobile solid carbon material(s), water, etc.) from the reaction chamber 204 of the reactor 200 as a reaction product stream 212.

While various embodiments herein describe or illustrate a single support structure 100 within the reactor 200, a multiple support structures may be provided within the reactor 200. Each of the support structures may be substantially the same, or at least one of the support structures may be different than at least one other of the support structures. Providing multiple support structures within the reactor 200 may facilitate the simultaneous formation of multiple catalytic assemblies. By way of non-limiting, the reactor 200 may be at least partially filled with a plurality of support structures (e.g., steel rings, such as steel Raschig rings) such that a carbon material (e.g., the carbon material 118) is formed on catalyst-containing surfaces of each of the support structures.

In operation, the support structure 100 may be provided (e.g., mounted) in the reaction chamber 204 of the reactor 200, and the gaseous reaction stream 210 may be introduced into the reaction chamber 204 through the reaction gas inlet 206. The carbon oxide and the gaseous reducing material of the gaseous reaction stream 210 may be reacted within the reaction chamber 204 (e.g., using one or more of Equations 1, 4, and 5 under the previously described processing conditions) of the reactor 200 to form the solid carbon structures on the catalyst-containing surfaces of the support structure 100. The unreacted reaction gases (if any) and the reaction products may be removed from the reaction chamber of the reactor 200 as the reaction product stream 212 through the reaction product outlet 208. The catalytic assembly 101 (FIG. 1C) may then be removed from the reaction chamber 204 of the reactor 200, and may be utilized as desired (e.g., incorporated into another system utilizing catalyst-containing structures, such as a catalytic conversion system of an automobile, an industrial plant, etc.). The reactor 200 may be operated in a batch mode, or may be operated in a continuous mode.

Referring to FIG. 3, in additional embodiments, a support structure 300 may be exposed to the carbon oxide and the gaseous reducing material without using a separate reactor (e.g., without the reactor 200 of FIG. 2). The support structure 300 may be substantially similar to the support structure 100 previously described in relation to FIGS. 1A-1C, except that a first (e.g., outer) structure 302 of the support structure 300 may, itself, define at least two end caps 307, a reaction gas inlet 306 extending through at least one of the end caps 307, and a reaction product outlet 308 extending through at least one other of the end caps 307. The reaction gas inlet 306 may be configured to deliver a gaseous reaction stream 310 including the carbon oxide and the gaseous reducing material into the support structure 300, and the reaction gas outlet 308 may be configured to remove unreacted reaction gases (if any) and reaction products (e.g., mobile solid carbon material(s), water, etc.) from the support structure 300 as a reaction product stream 312.

In operation, the gaseous reaction stream 310 may be introduced into the support structure 300 through the reaction gas inlet 306. The carbon oxide and the gaseous reducing material of the gaseous reaction stream 310 may be reacted within the support structure 300 (e.g., using one or more of Equations 1, 4, and 5 under the previously described processing conditions) to form the solid carbon structures on the catalyst-containing surfaces therein. The unreacted reaction gases (if any) and the reaction products may be removed from the support structure 300 as the reaction product stream 312 through the reaction product outlet 208. The resulting catalytic assembly (not shown) may be substantially similar to the catalytic assembly 101 of FIG. 1C (except for the configuration of the first structure 302), and may be utilized as desired (e.g., incorporated into another system utilizing catalyst-containing structures, such as a catalytic conversion system of an automobile, an industrial plant, etc.).

The methods and systems of the disclosure facilitate the simple and cost-effective production of a catalytic assembly 101. The catalytic assembly 101 may exhibit increased catalyst material surface area and support structure surface area as compared to many conventional catalytic assemblies, and may, therefore, also exhibit greater catalytic activity per catalyst amount as compared to such conventional catalytic assemblies. The structure of the catalytic assembly 101 (e.g., catalyst nanoparticles bound to solid carbon structures on surfaces of a support structure 100) may also facilitate reduced pressure drop, reduced catalyst nanoparticle agglomeration, and increased catalyst nanoparticle retention as compared to many conventional catalytic assemblies.

1. A method of forming a catalytic assembly comprising:
forming a support structure comprising at least one surface comprising at least one catalyst material; and
forming at least one mounted nanocatalyst on the at least one support structure, the at least one mounted nanocatalyst comprising a nanoparticle of the at least one catalyst material bound to a nanostructure.

2. The method of claim 1, wherein forming a support structure comprises forming nested structures each comprising at least one catalyst-containing surface comprising the at least one catalyst material.

3. The method of claim 2, wherein forming nested structures comprises forming greater than or equal to two structures in a nested relationship.

4. The method of claim 2, wherein forming nested structures comprises forming each of the nested structures to comprise a hollow and elongated structure.

5. The method of claim 2, wherein forming nested structures comprises forming each of the nested structures to be substantially concentrically aligned relative to each other of the nested structures.

6. The method of claim 2, wherein forming nested structures comprises forming at least one of the nested structures to exhibit at least one of a longitudinal axis offset from that of the support structure and a lateral axis offset from that of the support structure.

7. The method of claim 2, wherein forming nested structures comprises forming the support structure to comprise chambers substantially isolated from one another by the nested structures.

8. The method of claim 2, wherein forming nested structures each comprising at least one catalyst-containing surface comprising the at least one catalyst material comprises forming a catalyst-containing surface of at least one of the nested structures to comprise a different catalyst material than a catalyst containing surface of at least one other of the nested structures.

9. The method of claim 2, wherein forming nested structures each comprising at least one catalyst-containing surface comprising the at least one catalyst material comprises forming the at least one catalyst containing surface of each of the nested structures to comprise at least one element selected from Groups 5 through 10 of the Periodic Table of Elements.

10. The method of claim 1, wherein forming at least one mounted nanocatalyst on the support structure comprises forming the at least one mounted nanocatalyst on the at least one surface.

11-13. (canceled)

14. A catalytic assembly, comprising:
a support structure comprising at least one surface comprising at least one catalyst material; and
at least one mounted nanocatalyst comprising at least one nanoparticle of the at least one catalyst material bound to at least one nanostructure bound to the least one support structure.

15. The catalytic assembly of claim 14, wherein the support structure comprises nested structures each comprising at least one catalyst-containing surface comprising the at least one catalyst material.

16. The catalytic assembly of claim 15, wherein at least one of the nested structures comprises a substantially homogenous distribution of the at least one catalyst material.

17. The catalytic assembly of claim 15, wherein at least one of the nested structures comprises a substantially heterogeneous distribution of the at least one catalyst material.

18. The catalytic assembly of claim 15, wherein at least one of the nested structures comprises a substantially hollow and elongated shape.

19. (canceled)

20. The catalytic assembly of claim 15, wherein at least one of the nested structures comprises a sidewall exhibiting at least one perforation extending at least partially therethrough.

21. (canceled)

22. The catalytic assembly of claim 14, wherein the at least one nanostructure comprises at least one of a carbon nanotube, a carbon nanofiber, and a graphitic nanofiber.

23. A system for forming a catalytic assembly, comprising:
a reactor configured to withstand temperatures up to about 1200° C. and pressures up to about 6.90×10⁹ Pascals, the reactor comprising:
a shell at least partially defining a reaction chamber configured to receive at least one support structure, the shell configured for placing the at least one support structure within the reaction chamber and for removing the at least one support structure from the reaction chamber;
a reaction gas inlet extending through an end cap of the shell and configured to deliver a gaseous reaction stream into the reaction chamber; and
a reaction gas outlet extending through another end cap of the shell and configured to remove a reaction product stream from the reaction chamber.

24. The system of claim 23, wherein the at least one support structure comprises nested structures each comprising at least one catalyst-containing surface.

25. The system of claim 23, wherein the gaseous reaction stream comprises at least one carbon oxide and at least one gaseous reducing material.
